(19) United States
(12) Patent Application Publication
(10) Pub. No.: US 2018/0016084 A1
(43) Pub. Date: Jan. 18, 2018

(54) FOLDABLE INSULATING BOX

(71) Applicant: Zhejiang Natural Travel Goods Co., Ltd., Taizhou City (CN)

(72) Inventors: Yonghui XIA, Taizhou City (CN); Zhijian MA, Taizhou City (CN); Jinglong CAO, Taizhou City (CN)

(21) Appl. No.: 15/217,031

(22) Filed: Jul. 22, 2016

(30) Foreign Application Priority Data
Jul. 15, 2016 (CN) 2016105658721

(51) Int. Cl. B65D 81/38; A45C 13/10; A45C 11/20; A61J 1/16; A45C 7/00

(52) U.S. Cl. CPC B65D 81/3897; A61J 1/165; A45C 7/0077; A45C 11/20; A45C 13/103

(57) ABSTRACT

The present invention relates to the field of thermal insulation devices, and particularly to a foldable thermal insulation case. It includes a case body, a case lid covered on the case body and a liner provided inside the case body. The liner includes a bottom plate corresponding to a bottom wall of the case body and side plates corresponding one to one to sidewalls of the case body. There are a collapsed state and an unfolded state for the liner. When the liner is in the unfolded state, each of the side plates stays upright around the bottom plate and is jointed with the bottom plate; in this way, the individual side plates and the bottom plate support the case body, and the case body is unfolded. When the liner is converted from the unfolded state into the collapsed state, that is, the side plates are bent downwards with respect to the bottom plate and stacked on the bottom plate, the case body may be folded downwards, and the size of the thermal insulation case is reduced after the case body is folded. Therefore, the invention enables the thermal insulation case to be folded, and the size of the thermal insulation case to be reduced effectively.

### TECHNICAL FIELD

The present invention relates to the field of thermal insulation devices, and particularly to a foldable thermal insulation case.

### BACKGROUND ART

In daily life, thermal insulation cases are needed to make foods, medicines and the like thermally insulated, transported or stored. Generally, the thermal insulation case includes a case body with an upper opening, and a case lid positioned on the top of the case body. A rear side of the case lid is fixedly connected with the case body, and a left side, a right side and a front side of the case lid are connected with the case body by a zipper. With such a structure design, the upper opening of the case body is closed. In general, the case body and the case lid each include an inner layer and an outer layer which are made of a waterproof material; alternatively, an intermediate layer made of a thermal insulation material is provided between the inner layer and the outer layer, to further improve the thermal insulation capacity.

For example, referring to FIG. 1 of the description, a thermal insulation bag having an outer layer made of Oxfold cloth and an inner layer made of an aluminum film (for example, a thermal insulation bag for placing a lunchbox) is shown. Such a thermal insulation bag is not provided with an intermediate layer made of a thermal insulation material between the inner layer and the outer layer thereof, thus having a poor thermal insulation effect. However, since both the Oxfold cloth and the aluminum film are foldable flexible materials, this thermal insulation bag may bear compressional deformation, so as to reduce its size.

Alternatively, the outer layer is made of Oxfold cloth, the inner layer is made of an aluminum film, and thermal insulation PE foam or another foaming material is filled between the outer layer and the inner layer. Such a thermal insulation bag has a better thermal insulation effect due to the provision of the thermal insulation PE foam or the another foaming material; however, it cannot be folded since the thermal insulation PE foam or the another foaming material is a rigid material.

Therefore, the problem existing in the thermal insulation case in the prior art is that it is unable to provide foldability and thermal insulation simultaneously.

### DISCLOSURE OF THE PRESENT INVENTION

An object of the present invention is to provide a foldable thermal insulation case, so as to solve the technical problem that the thermal insulation case in the prior art cannot provide foldability and thermal insulation simultaneously.

The present invention discloses a foldable thermal insulation case, which includes a case body, a case lid covered on the case body and a liner provided inside the case body;
the liner includes a bottom plate corresponding to a bottom wall of the case body and side plates corresponding one to one to sidewalls of the case body;
when the liner is in an unfolded state, each of the side plates and the bottom plate are jointed with each other to define a cavity for accommodating an article, and to function as supporting inside the case body; and
when the liner is in a collapsed state, the case body losses support by the liner and can be folded.

Further, in each pair of the sidewall and the side plate which correspond to each other:
a parent binding strip is provided on the side plate, and a child binding strip used in conjunction with the parent binding strip is provided on the sidewall; or
a parent binding strip is provided on the sidewall, and a child binding strip used in conjunction with the parent binding strip is provided on the side plate.

Further, each of the side plates and/or the bottom plate include a jacket layer and a filling layer, with the filling layer accommodated within the jacket layer. The filling layer may effectively block thermal energy exchange between the inside and outside of the case body, thus avoiding thermal energy dissipation. The jacket layer may in one aspect protect the filling layer, and in another aspect, the jacket layer may also radiate heat radiated onto a surface thereof back into the case body, thus improving the thermal insulation performance of the thermal insulation case effectively.

Further, the liner further includes a cover plate connected detachably with an inner wall of the case lid.

Further, the cover plate includes a jacket layer and a filling layer, with the filling layer accommodated within the jacket layer.

Further, the filling layer is made of polypropylene and/or polystyrene foam. Since the filling layer is made of polystyrene foam which is a porous material with good thermal insulation performance, energy loss caused by air convection between the inside and outside of the case body is avoided. Therefore, the thermal insulation performance of the thermal insulation case may be improved.

Further, the bottom plate is separable from each of the side plates, and each of the side plates is clamped between the bottom plate and an inner wall of the case body when the liner is in the unfolded state.

Further, the bottom plate is connected with each of the side plates by a spacing strip around which each of the side plates can be folded or unfolded.

Further, the case body is formed integrally.

Further, the case body is further provided therein with a waterproof layer matching with an inner cavity of the case body, with the water proof layer connected detachably with the case body.

Combining the above technical solutions, the present invention discloses a foldable thermal insulation case including a case body, a case lid and a liner. The liner includes a bottom plate corresponding to a bottom wall of the case body and side plates corresponding one to one to sidewalls of the case body, and the bottom plate and the side plates provided around the bottom plate define a cavity for accommodating an article. There are a collapsed state and an unfolded state for the liner. When the liner is in the unfolded state, each of the side plates stays upright around the bottom plate and is jointed with the bottom plate; in this way, the individual side plates and the bottom plate support the case body, and the case body is unfolded. When the liner is converted from the unfolded state into the collapsed state, that is, the side plates are bent downwards with respect to the bottom plate and stacked on the bottom plate, the case body may be folded downwards, and the size of the thermal insulation case is reduced after the case body is folded. Therefore, the invention enables the thermal insulation case to be folded, and the size of the thermal insulation case to be reduced effectively.

### BRIEF DESCRIPTION OF DRAWINGS

In order to more clearly illustrate technical solutions of particular embodiments in the present invention and of the prior art, drawings which are needed for description of the particular embodiments or the prior art will be briefly introduced hereinafter. Apparently, drawings below merely show some embodiments of the present invention, and other drawings can also be obtained, in light of these drawings, by those skilled in the art without paying any creative effort.

FIG. 1 is a structural schematic view of a thermal insulation case in the prior art;

FIG. 2 is a structural schematic view of a foldable thermal insulation case provided by the present invention;

FIG. 3 is a top view of the foldable thermal insulation case provided by the present invention;

FIG. 4 is a structural schematic view of a liner in an assembled state;

FIG. 5 is a schematic view showing a folding way of the liner;

FIG. 6 is a plan schematic view of the liner in an unfolded state; and

FIG. 7 is a structural schematic view of the foldable thermal insulation case provided by the present invention in a collapsed state.

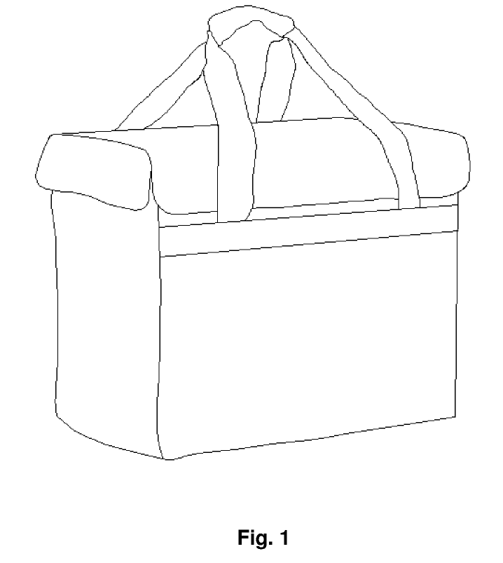

### REFERENCE SIGNS ARE AS FOLLOWS

1-case lid; 2-case body; 3-liner; 4-parent binding strip; 5-child binding strip; 6-spacing strip; 31-bottom plate; 32-side plate; 321-first side plate; and 322-second side plate.

### DETAILED DESCRIPTION OF EMBODIMENTS

The technical solutions of the present invention will be described clearly and completely hereinafter, in conjunction with drawings. Apparently, some but not all of embodiments of the present invention are described. All of the other embodiments, obtained by those skilled in the art based on the embodiments of the present invention without paying any creative effort, fall within the scope of protection of the present invention.

In the description of the present invention, it should be noted that orientational or positional relationships indicated by terms, such as “center”, “upper”, “lower”, “left”, “right”, “vertical”, “horizontal”, “inner”, and “outer”, are based on the orientational or positional relationships shown in the drawings, merely for facilitating the description of the present invention and simplifying the description, rather than indicating or implying that the related devices or elements have to be in the specific orientation or configured and operated in the specific orientation, therefore they shall not be construed as limiting the present invention. Furthermore, terms, such as “first”, “second” and “third”, are only used for illustrative purposes, and shall not be construed as indicating or implying a relative importance.

In the description of the present invention, it should be noted that, terms, such as “install”, “connect” and “connection”, should be broadly interpreted, unless specified and defined otherwise. For example, it may be a fixed connection, a detachable connection, or an integral connection; or it may be a mechanical connection or an electrical connection; or it may be a direct connection, an indirect connection through an intermediate medium, or it may be an inner communication between two elements. For those skilled in the art, specific meanings of the above terms in the present invention can be understood based on specific situations.

### First Embodiment

The embodiment discloses a foldable thermal insulation case, which specifically includes a case lid 1, a case body 2 and a liner 3.

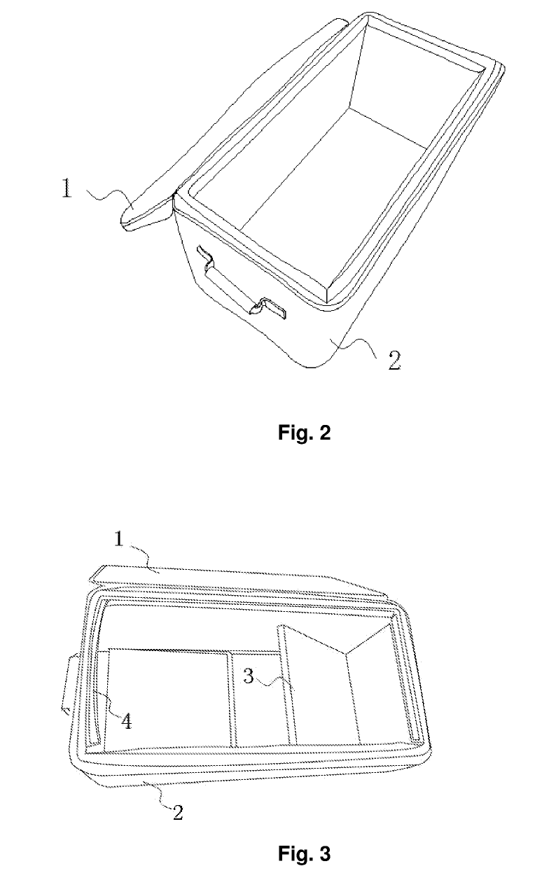

In an optional solution of the embodiment, the case lid 1 is covered on the case body 2, with a left side, a right side and a front side of the case lid 1 connected with the case body 2 by a connector, and a rear side of the case lid 1 connected integrally with the case body 2. More preferably, the connector is set as a zipper. Even more preferably, the connector is set as a waterproof zipper. Reference is made to both FIGS. 2 and 3.

To improve the thermal insulation performance of the case lid 1, i.e., to prevent energy from dissipating from the case lid 1, a cover plate is provided at a side of the case lid 1 near the case body 2, in which the cover plate is used to seal an upper opening of the liner 3 when the case body 2 is closed by the case lid 1. The cover plate may be connected with the case lid 1 by for example a Velcro, a zipper or an adhesive layer, but the connection is not limited thereto.

In an optional solution of the embodiment, the case body 2 is used to accommodate the liner 3, and the case body 2 may be unfolded under support of the liner 3. After the case body 2 is unfolded, an inner cavity of the case body 2 is used to hold an article which needs to be thermally insulated. After losing the supporting force exerted by the liner 3, the case body 2 may be folded, thereby achieving reduction in size of the thermal insulation case, and improving the portability.

To improve waterproofness of the case body 2, the case body 2 is set to be made of Oxfold cloth. The Oxfold cloth can be easily cleaned and dried quickly, and it further has better waterproofness.

To improve the thermal insulation performance of the case body 2, the case body 2 is formed integrally, with the forming method not limited to hot pressing forming. Such an integrally formed structure can improve the thermal insulation effect of the thermal insulation case significantly for the following reasons: an outer layer of the thermal insulation case in the prior art is generally formed by jointing pieces of Oxfold cloth, with adjacent pieces of Oxfold cloth stitched together through sewing process, which causes a poor thermal insulation effect since cold air or hot air inside the thermal insulation case may dissipate easily through a seam formed due to the jointing; however, the case body 2 in the embodiment is formed integrally without any seam formed between the side faces and the bottom face of the case body 2, which does not involve the problem that the cold air or hot air inside the thermal insulation case dissipates through the seam. Therefore, the thermal insulation case provided by the embodiment can significantly improve the thermal insulation performance thereof, as compared with the thermal insulation case in the prior art.

To facilitate the case body 2 to be unfolded, the case body 2 may be provided on its upper end with a flange extending towards the inside of the case body 2, with an upper end of the liner 3 abutting against a lower surface of the flange. The side plates of the liner 3, during their arising, drive the case body 2 to be unfolded completely by applying an upward supporting force to the flange. Preferably, the flange may be set as Oxfold cloth connected integrally with the case body 2.

There are a collapsed state and an unfolded state for the case body 2, which is detailed as follows.

When the case body 2 is in the unfolded state, the liner 3 is accommodated within the case body 2, and at this time, the side plates 32 of the liner 3 are respectively perpendicular to edges of the bottom plate 31, and the case body 2 is unfolded under the support of the side plates 32. After the case body 2 is unfolded, the liner 3 is connected with the case body 2 with a connector (for example, a Velcro), and the case lid 1 is covered on the case body 2. At this time, the cover plate of the case lid 1 cooperates with an upper opening of the liner, thereby forming an enclosed space, where the enclosed space is used to avoid energy loss caused by convection between the cold air or the hot air inside the case body and the air outside.

When the case body 2 is in the collapsed state, the liner 3 is accommodated within the case body 2, and at this time, the side plates 32 of the liner 3 are in a folded state, i.e., the side plates 32 of the liner 3 are placed in parallel with the bottom plate 31, and the case body 2 may be folded arbitrarily to realize the reduction in size when losing the supporting force exerted by the liner 3. Of course, to facilitate the operation of an operator, a folding mark may be preset on the case body 2. In this case, the operator may fold the case body 2 conveniently by means of the preset folding mark. Moreover, the presetting of the folding mark makes it possible to improve the convenience of operation and the aesthetic extent of a product after being folded.

To further reduce the size of the thermal insulation case in the collapsed state, and further improve the portability, the case body 2 is further modified. Specifically, referring to FIG. 7, a connector, which for example may be a zipper, is provided around an upper surface of the case lid 1 and around a lower surface of the case body 2, and in this way, the case body 2 in the collapsed state may be completely enclosed between the upper surface of the case lid 1 and the lower surface of the case body 2 by the connector (zipper). If there is a need to move the thermal insulation case, any portion of the thermal insulation case may be picked up without deforming the thermal insulation case in the collapsed state, which brings convenience for the picking operation and may further improve the aesthetic extent of a product after being folded.

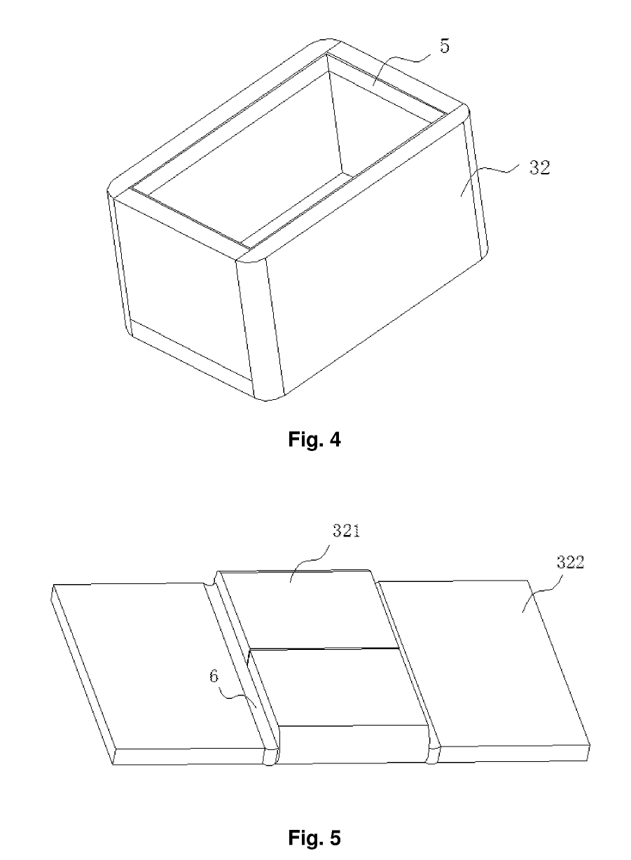

In the embodiment, the liner 3 is provided within the case body 2, and the liner 3 includes a bottom plate 31 and side plates 32. The bottom plate 31 and the side plates 32 provided around the bottom plate 31 define a cavity for accommodating an article, and the side plates 32 may be bent downwards with respect to the bottom plate 31 and stacked on the bottom plate 31. The bottom plate 31 and the side plates 32 of the liner 3 abut against inner walls of the case body 2, to support the case body 2. The liner 3 is used to provide the thermal insulation function and to make the case body 2 stretched up, that is, the sidewalls of the case body 2 may be unfolded upwards under the support of the side plates of the liner 3 and the case body 2 may be eventually unfolded completely when the liner 3 is placed in an inner cavity of the case body 2. Reference is made to FIGS. 4, 5 and 6 together.

To improve the firmness of the connection between the liner 3 and the case body 2, preferably, the liner 3 and the case body 2 are connected by a connector. As one of the particular implementations, the connector may be set as binding strips. For example, a parent binding strip 4 is provided on the side plate, and a child binding strip 5 used in conjunction with the parent binding strip 4 is provided on the sidewall; or, a parent binding strip 4 is provided on the sidewall, and a child binding strip 5 used in conjunction with the parent binding strip 4 is provided on the side plate. Of course, positions of the binding strips may be set according to actual usage requirements. For example, the parent binding strip 4 may also be provided on a top end of the side plate 32 or on an end surface at one side of the side plate 32 near the case body 2; accordingly, the position of the child binding strip 5 may be adjusted in accordance with the specific position of the parent binding strip 4.

To further improve the firmness of the connection between the liner 3 and the case body 2, preferably, side faces and a bottom face of the liner 3 are bonded to inner side faces and the bottom face of the case body 2 by an adhesive layer, respectively. It should be noted that the adhesive layer is reusable, that is, the side plates 32 of the liner 3, after being bent for multiple times, can still return and can be attached to the inner walls of the case body 2 by means of the adhesive layer.

In an optional solution of the embodiment, the side plates 32, the bottom plate 31 and the cover plate each include a jacket layer and a filling layer, with the filling layer accommodated within the jacket layer.

The filling layer is used to keep the temperature of the liner 3 and support the case body 2. Preferably, the filling layer is set to be made of a porous foaming material, and the jacket layer is set to be made of aluminum foil. More specifically, the filling layer is set to be made of XPS (extruded polystyrene) cotton and/or PP (propene polymer) board. The XPS cotton (polystyrene foam) has a closed-cell honeycomb structure which makes the XPS cotton have low water absorption, low thermal conductivity, strong pressure resistance and strong ageing resistance. The PP board (polypropylene board) has excellent chemical resistance, thermal resistance and impact resistance. The PP board is mainly used for ensuring the strength of the liner 3, while the XPS cotton is mainly used for thermal insulation.

The jacket layer is sleeved on the outside the filling layer, and it is mainly used for sealing the filling layer, waterproofing and heat insulating. More preferably, the jacket layer is set to be made of aluminum foil. The aluminum foil may reflect a part of the thermal energy in such a manner that the thermal energy radiated from a cavity of the liner 3 onto a surface of the aluminum foil may be reflected back into the cavity of the liner 3 by the aluminum foil, thereby reducing thermal loss and thus improving the thermal insulation performance of the thermal insulation case. In addition, the aluminum foil may also be waterproofing, thereby preventing water inside the cavity of the liner 3 from penetrating through the thermal insulation case.

In an optional solution of the embodiment, the liner 3 may further include a spacing strip 6. The bottom plate 31 and each of the side plates 32 are connected by the spacing strip 6, with the jacket layer of each side plate 32 connected integrally with the jacket layer of the bottom plate 31 by the spacing strip 6. Each of the side plates 32 may be folded or unfolded around the spacing strip 6, which is detailed as follows.

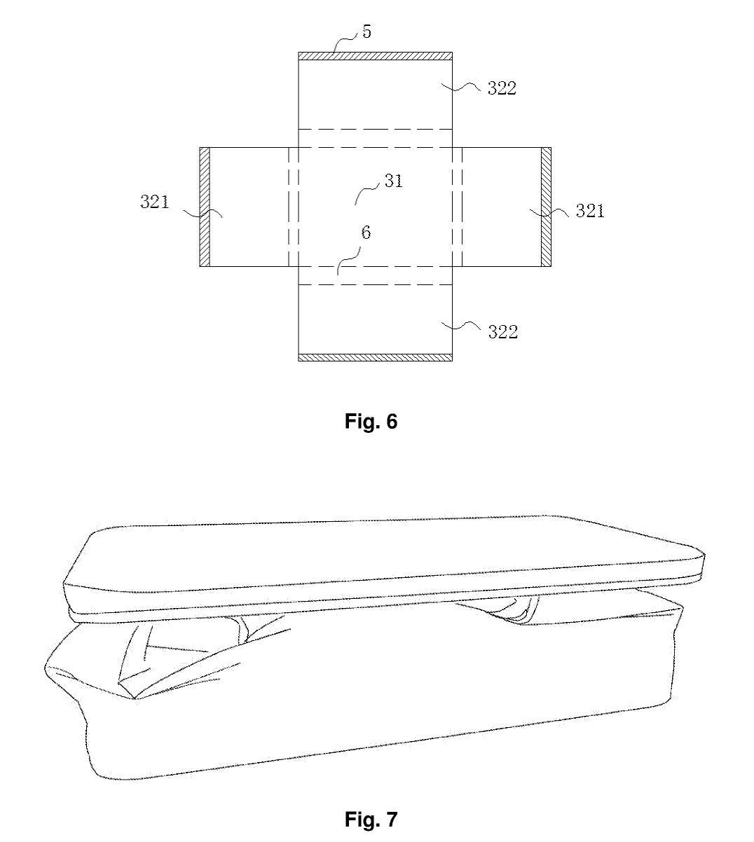

Referring to FIG. 6, FIG. 6 illustrates a top view of the liner 3 (not including the cover plate) in a flattened state. The liner 3 is in a cruciform structure. In more detail, the liner 3 includes a bottom plate 31, first side plates 321 and second side plates 322, in which there are two first side plates 321 and two second side plates 322. When the liner 3 is in the flattened state, the first side plates 321 are located at both sides of the bottom plate 31 in a lateral direction respectively, and the second side plates 322 are located at both sides of the bottom plate 31 in a vertical direction respectively. It should be noted that, the terms “lateral direction” and “vertical direction” indicated herein can be understood by referring to FIG. 6, specifically, the term “lateral direction” refers to a direction of a connecting line of the two first side plates 321 and the bottom plate 31, and the term “vertical direction” refers to a direction of a connecting line of the two second side plates 322 and the bottom side 31. The spacing strip 6 is provided between each first side plate 321 and the bottom plate 31 and between each second side plate 322 and the bottom plate 31. The spacing strip 6 is mainly used to reserve a sufficient free gap for the bending operation of the first side plates 321 and the second side plates 322. It should be understood that the four spacing strips 6 may have inconsistent widths in accordance with various actual folding ways.

The folding ways of the liner 3 are described in detail as follows.

First way: the bottom plate 31 is of a rectangle shape, the first side plates 321 are provided at both sides of the bottom plate 31 in a width direction respectively, and the second side plates 322 are provided at both sides of the bottom plate 31 in a length direction respectively. Firstly, the two first side plates 321 are folded onto the bottom plate 31 such that the two first side plates 321 are located in a same layer on the bottom plate 31; then one of the second side plates 322 is folded onto the first side plates 321; and finally, the other second side plate 322 is folded onto the preceding second side plate 322.

Second way: the bottom plate 31 is of a rectangle shape, the first side plates 321 are provided at both sides of the bottom plate 31 in a width direction respectively, and the second side plates 322 are provided at both sides of the bottom plate 31 in a length direction respectively. Firstly, one of the first side plates 321 is folded onto the bottom plate 31; then the other remaining first side plate 321 is folded onto the preceding first side plate 321; and finally, the two second side plates 322 are folded in sequence.

Third way: the bottom plate 31 is of a rectangle shape, and the first side plates 321 are provided at both sides of the bottom plate 31 in a width direction respectively, and the second side plates 322 are provided at both sides of the bottom plate 31 in a length direction respectively. Firstly, one of the first side plates 321 is folded onto the bottom plate 31; then one of the second side plates 322 is folded onto the aforementioned first side plate 321; and finally, the remaining first side plate 321 and the remaining second side plate 322 are folded in sequence.

It should be noted that there may be provided a plurality of folding ways for the liner 3 according to actual usage requirements, and the plurality of folding ways can be obtained by those skilled in the art through limited creative work, which will not be enumerated herein for saving space. It should be understood that all thermal insulation cases adopting different folding ways shall fall within the scope of protection of the technical solution claimed by the present invention.

To further improve the firmness of the connection between the first side plate 321 and the second side plate 322, a position limiting mechanism is provided at a place where the first side plate 321 and the second side plate 322 are connected. The position limiting mechanism is used to limit the positions of the first side plates 321 and the second side plates 322 when the liner 3 is in an assembled state. There are a variety of structural forms for the position limiting mechanism.

For example, it may be achieved in such a manner that, when the liner is in the assembled state, a step structure is provided at a vertical edge of the first side plate 321, and the second side plates 322 is matched with the step structure at a place where the second side plate 322 and the first side plate 321 are connected. The step structure may avoid displacement of the second side plates 322, thereby effectively securing the first side plates 321 and the second side plates 322.

For another example, intermeshing sawtooth structures are provided at a place where the first side plate 321 and the second side plate 322 are connected, or intermeshing sawtooth structures are provided at a place where the first side plate 321 and the bottom plate 31 are connected and at a place where the second side plate 322 and the bottom plate 31 are connected. These sawtooth structures secure the first side plates 321, the second side plates 322 and the bottom plate 31 by mortise and tenon joints. Of course, there may be provided a plurality of sawtooth structures, for example, a discontinuous sawtooth structure or a continuous sawtooth structure.

For another example, an adhesive layer is provided between vertical edges of the first side plate 321 and the second side plate 322, such that the first side plate 321 and the second side plate 322 are connected by the adhesive layer.

To further improve waterproofness of the thermal insulation case, the case body 2 is further provided therein with a waterproof layer matching with an inner cavity of the case body 2, with the waterproof layer connected detachably with the case body 2. Specifically, the waterproof layer is set to be in a pocket-like structure with an upper opening, and an upper edge of the waterproof layer extends horizontally and outwardly such that the waterproof layer is connected detachably with the upper end surface of the case body 2 through thus horizontally extending portion. For example, it may be achieved in such a manner that a child binding strip 5 is provided at a lower side of the horizontally extending portion of the waterproof layer, and a parent binding strip 4 used in conjunction with the above child binding strip is provided on the upper end surface of the case body 2. More specifically, the child binding strip 5 and the parent binding strip 4 may be set as a Velcro, a zipper, a button, or the like.

Combining the above technical solutions, the embodiment discloses a foldable thermal insulation case including a case body 2, a case lid 1 and a liner 3. The liner 3 includes a bottom plate 31 corresponding to a bottom wall of the case body 2 and side plates 32 corresponding one to one to sidewalls of the case body 2. The bottom plate 31 and the side plates 32 provided around the bottom plate 31 define a cavity for accommodating an article. There are a collapsed state and an unfolded state for the liner 3. When the liner 3 is in the unfolded state, each of the side plates 32 stays upright around the bottom plate 31 and is jointed with the bottom plate 31; in this way, the individual side plates 32 and the bottom plate 31 support the case body 2, and the case body 2 is unfolded. When the liner 3 is converted from the unfolded state into the collapsed state, that is, the side plates 32 are bent downwards with respect to the bottom plate 31 and stacked on the bottom plate 31, the case body 2 may be folded downwards, and the size of the thermal insulation case is reduced after the case body 2 is the folded. Therefore, the invention enables the thermal insulation case to be folded, and the size of the thermal insulation case to be reduced effectively.

Furthermore, the liner 3 includes a jacket layer and a filling layer, with the filling layer accommodated within the jacket layer. The filling layer may be effective for thermal insulation, thereby avoiding energy loss caused by air convection between the inside and outside of the case body 2. For example, in a case that the temperature outside the case body 2 is high and the temperature inside the case body 2 is low, there is a trend that the high temperature air radiates towards the low temperature air to achieve a uniform temperature, thereby causing a problem that the thermal insulation case has a poor thermal insulation effect. Since the foldable thermal insulation case provided in the embodiment is provided with a filling layer, which effectively blocks air convection between the inside and outside of the case body 2 to prevent cold air from flowing out of the case body 2, a better thermal insulation effect can be achieved. Moreover, the jacket layer may in one aspect protect the filling layer, and in another aspect, the jacket layer may also radiate heat radiated onto a surface thereof back into the case body 2. Therefore, the technical solution provided by the embodiment may also improve the thermal insulation performance.

### Second Embodiment

This embodiment is another preferred solution in parallel with the First Embodiment. The technical solutions disclosed in the First Embodiment, except for the following distinguishing technical feature, fall within the scope disclosed in this embodiment, and will not be repeated herein. This embodiment differs from the First Embodiment in that the liner 3 has a different structure, which is detailed as follows.

This embodiment provides a foldable thermal insulation case, which includes a case body 2, a case lid 1 and a liner 3. The liner 3 includes a bottom plate 31 and side plates 32. The bottom plate 31 and the side plates 32 provided around the bottom plate 31 define a cavity for accommodating an article. The side plates 32 may be bent downwards with respect to the bottom plate 31 and stacked on the bottom plate 31. There are a collapsed state and an unfolded state for the case body 2.

The bottom plate 31 is separable from each of the side plates 32, and each of the side plates 32 is clamped between the bottom plate 31 and an inner wall of the case body 2. More specifically, the liner 3 (not including a cover plate) includes four side plates 32 and one bottom plate 31. Each side plate 32 is clamped in a gap between the bottom plate 31 and an inner wall of the case body 2 in such a manner that a lower portion of the side plate 32 is secured by a force generated by the abutment between the bottom plate 31 and the case body 2, and an upper portion of the side plate 32 is secured through mutual cooperation between a child binding strip 5 provided on the upper portion of the side plate 32 and a parent binding strip 4 provided on the upper portion of the case body 2.

There are a plurality of schemes for clamping the side plates 32 around the bottom plate 31. The case body 2 has a length equal to a sum of a length of the bottom plate 31 and thicknesses of two side plates 32 located at both sides of the bottom plate 31. It should be understood that equivalent changes or modifications made from the scope of present invention patent application should still fall within the scope of the present invention.

It should also be noted that terms “bottom plate” and “side plate” used herein each refer to a plate having a shape of a length, a width and a thickness, with the length and the width thereof be much greater than the thickness thereof.

Finally, it should be noted that, the above embodiments are only illustrative of the technical solutions of the present invention, rather than limiting. Although the present invention has been described in detail with reference to the forgoing embodiments, those skilled in the art should appreciate that they can still make modifications to the technical solutions described in the forgoing embodiments or make equivalent substitutions to a part or all of the technical features disclosed therein. Such modifications or substitutions shall not cause the essence of the corresponding technical solutions to depart from the scope of the technical solutions provided in the embodiments of the present invention.

1. A foldable thermal insulation case, comprising a case body, a case lid covered on the case body and a liner provided inside the case body,
wherein the liner comprises a bottom plate corresponding to a bottom wall of the case body and side plates corresponding one to one to sidewalls of the case body,
when the liner is in an unfolded state, each of the side plates and the bottom plate are jointed with each other to define a cavity for accommodating an article, and to function as supporting inside the case body; and
when the liner is in a collapsed state, the case body losses support by the liner and can be folded.

2. The foldable thermal insulation case according to claim 1, wherein in each pair of the sidewall and the side plate which correspond to each other:
a parent binding strip is provided on the side plate, and a child binding strip used in conjunction with the parent binding strip is provided on the sidewall; or
a parent binding strip is provided on the sidewall, and a child binding strip used in conjunction with the parent binding strip is provided on the side plate.

3. The foldable thermal insulation case according to claim 1, wherein each of the side plates and/or the bottom plate comprise a jacket layer and a filling layer, with the filling layer accommodated within the jacket layer.

4. The foldable thermal insulation case according to claim 3, wherein the filling layer is made of polypropylene and/or polystyrene foam.

5. The foldable thermal insulation case according to claim 1, wherein the liner further comprises a cover plate connected detachably with an inner wall of the case lid.

6. The foldable thermal insulation case according to claim 5, wherein the cover plate comprises a jacket layer and a filling layer, with the filling layer accommodated within the jacket layer.

7. The foldable thermal insulation case according to claim 6, wherein the filling layer is made of polypropylene and/or polystyrene foam.

8. The foldable thermal insulation case according to claim 1, wherein the bottom plate is separable from each of the side plates, and each of the side plates is clamped between the bottom plate and an inner wall of the case body when the liner is in the unfolded state.

9. The foldable thermal insulation case according to claim 2, wherein the bottom plate is separable from each of the side plates, and each of the side plates is clamped between the bottom plate and an inner wall of the case body when the liner is in the unfolded state.

10. The foldable thermal insulation case according to claim 3, wherein the bottom plate is separable from each of the side plates, and each of the side plates is clamped between the bottom plate and an inner wall of the case body when the liner is in the unfolded state.

11. The foldable thermal insulation case according to claim 4, wherein the bottom plate is separable from each of the side plates, and each of the side plates is clamped between the bottom plate and an inner wall of the case body when the liner is in the unfolded state.

12. The foldable thermal insulation case according to claim 5, wherein the bottom plate is separable from each of the side plates, and each of the side plates is clamped between the bottom plate and an inner wall of the case body when the liner is in the unfolded state.

13. The foldable thermal insulation case according to claim 1, wherein the bottom plate is connected with each of the side plates by a spacing strip around which each of the side plates can be folded or unfolded.

14. The foldable thermal insulation case according to claim 2, wherein the bottom plate is connected with each of the side plates by a spacing strip around which each of the side plates can be folded or unfolded.

15. The foldable thermal insulation case according to claim 3, wherein the bottom plate is connected with each of the side plates by a spacing strip around which each of the side plates can be folded or unfolded.

16. The foldable thermal insulation case according to claim 4, wherein the bottom plate is connected with each of the side plates by a spacing strip around which each of the side plates can be folded or unfolded.

17. The foldable thermal insulation case according to claim 5, wherein the bottom plate is connected with each of the side plates by a spacing strip around which each of the side plates can be folded or unfolded.

18. The foldable thermal insulation case according to claim 1, wherein the case body is formed integrally.

19. The foldable thermal insulation case according to claim 1, wherein the case body is further provided therein with a waterproof layer matching with an inner cavity of the case body, with the water proof layer connected detachably with the case body.

20. The foldable thermal insulation case according to claim 2, wherein the case body is further provided therein with a waterproof layer matching with an inner cavity of the case body, with the water proof layer connected detachably with the case body.
